(19) United States
(12) Patent Application Publication
(10) Pub. No.: US 2008/0255945 A1
(43) Pub. Date: Oct. 16, 2008

(54) Producing image data representing retail packages

(76) Inventors: Karl William Percival, Worsley (GB); Aaron Paul Williams, Hyde (GB)

Correspondence Address: JAMES C. WRAY, 1493 CHAIN BRIDGE ROAD, SUITE 300, MCLEAN, VA, 22101, US

(21) Appl. No.: 12/080,827

(22) Filed: Apr. 4, 2008

(30) Foreign Application Priority Data
Apr. 5, 2007 (GB) 07 06 751.5

(51) Int. Cl. G06Q 30/00

(52) U.S. Cl. 705/14

(57) ABSTRACT

The production of image data representing retail packages for publication purposes is shown. Data serving devices (102) are configured to communicate with users (104 to 108) over a network (101). The data serving devices include storage and processing capabilities for an item creation object (201) and a user interactive object (202). A three-dimensional model is selected within the item creation objects (201) in response to user input. Two-dimensional image data (305) is uploaded to the item creation object from the user via the network. The two-dimensional image data (305) is mapped as a texture (403) onto the three-dimensional model (401) by the image creation object to define created image data (407). The created image data is supplied to the interactive object (202) that returns interactive image data to an interactive user (104). The interactive object receives a definition of a preferred view from the interactive user and the interactive object renders (405) publication image data (503, 504, 505) for publication purposes.

### CROSS REFERENCE TO RELATED APPLICATIONS

This application claims priority from United Kingdom Patent Application No. 07 06 751.5, filed 5 Apr. 2007, the entire disclosure of which is incorporated herein by reference in its entirety.

### BACKGROUND OF THE INVENTION

1. Field of the Invention

The present invention relates to apparatus for producing image data representing retail packages for publication purposes. The invention also relates to a method of producing image data representing retail packages and a computer program for instructing a computer to perform steps for the production of image data representing retail packages for publication purposes.

2. Description of the Related Art

It is known to produce publications, such as advertisements, that include one or more retail products, such as the products sold in general purpose stores. Traditionally, these images are produced by known photographic techniques and having photographed the products, the resulting images may be “dropped in” to known publishing applications. It is also known to synthesise high definition images, possible using three-dimensional image creation packages. Computer graphics packages also exist for generating two-dimensional images. However, there has been a reluctance for publishers of documentation showing retail products and the packaging for retail products to make use of these available system, given the high level of skill required in order to achieve photo-realism.

### BRIEF SUMMARY OF THE INVENTION

According to an aspect of the present invention, there is provided apparatus for producing image data representing retail packages for publication purposes, comprising data serving devices, configured to communicate with a plurality of users over a network, wherein: said data serving devices include storage and processing capabilities for an item-creation object and a user-interactive object; a three dimensional model is selected within said item-creation object in response to user input via said network; two dimensional image data is uploaded to said item creation object from said user via said network; said two dimensional image data is mapped as a texture onto said three dimensional model by the image creation object to define created image data; said created image data is supplied to said interactive object; said interactive object returns interactive image data to an interactive user; said interactive object receives a definition of a preferred view from said interactive user; and said interactive object renders publication image data for publication purposes.

### BRIEF DESCRIPTION OF THE SEVERAL VIEWS OF THE DRAWINGS

FIG. 1 shows a networked environment that includes server devices;

FIG. 2 shows a schematic representation of the server device as identified in FIG. 1;

FIG. 3 details the functionality of an item creation object identified in FIG. 2;

FIG. 4 illustrates an example of a texture mapping;

FIG. 5 details the functionality of a user interaction object of the type identified in FIG. 2;

FIG. 6 shows an example of an image displayed to a user;

FIG. 7 details the functionality of an image storage object of the type identified in FIG. 2;

FIG. 8 illustrates an overall method for the production of image data;

FIG. 9 details procedures for defining a three-dimensional model of the type identified in FIG. 8; and

FIG. 10 details procedures for interacting with three-dimensional data, of the type identified in FIG. 8.

### DESCRIPTION OF THE BEST MODE FOR CARRYING OUT THE INVENTION

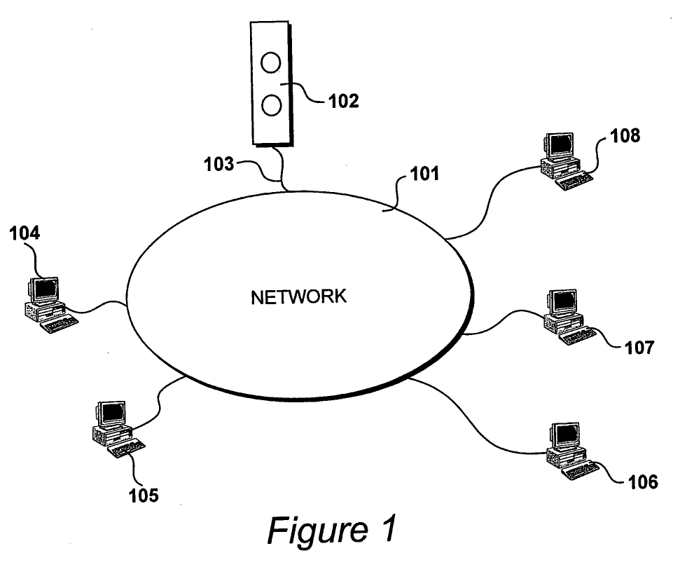

### FIG. 1

A networked environment is illustrated in FIG. 1. Network 507 may be a local network, a wide area network, a private internet or the publicly accessible Internet. Serving devices 102 communicate with the network 101 via a high bandwidth communication channel 103. The serving devices 102 represent apparatus for producing image data representing retail packages for publication purposes. Thus, the serving devices 102 are configured to communicate with a plurality of users via network 101.

For the purposes of illustration, users 104 to 108 are illustrated in FIG. 1, although it should be appreciated that the number of users having access to network 101 is likely to be substantially larger than that shown. Furthermore, it is likely that said users will come in at least two types. Namely, a first representing a direct user and a second representing an agency that would in turn provide services to many end users who do not have access to server devices 102 directly.

Server devices 102 include processing capabilities, storage capabilities and communication capabilities, as is well known in the art.

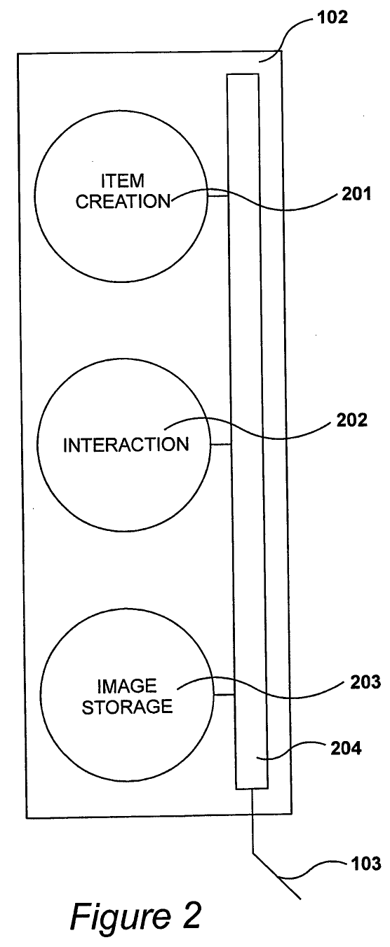

### FIG. 2

A schematic representation of server devices 102 is illustrated in FIG. 2. Storage and processing capabilities of the serving devices 102 provide for the establishment of an image creation object 201, a user-interactive object 202 and an image storage object 203. Furthermore, a communications channel 204 facilitates communication between objects 201 to 203, along with communication to network 101 via communication channel 103.

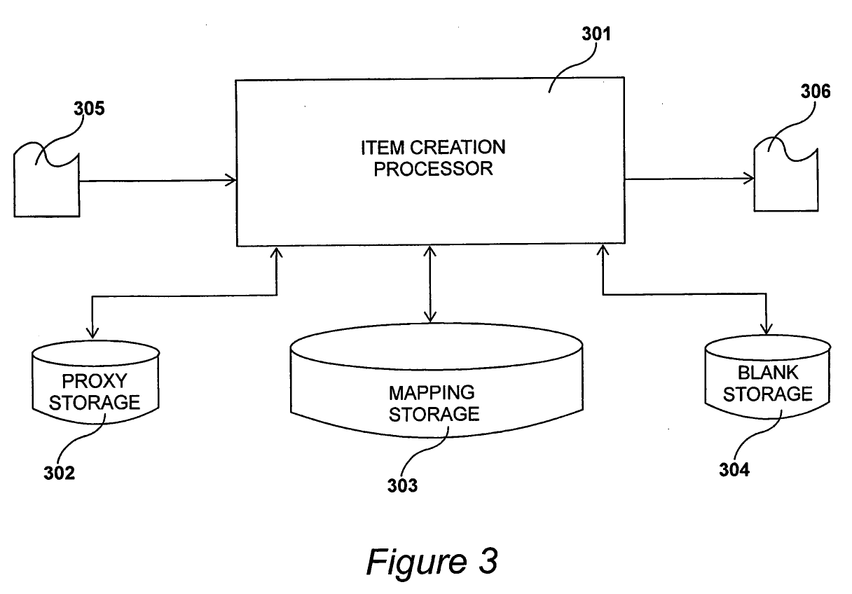

### FIG. 3

The functionality of item creation object 201 is illustrated in FIG. 3. An item creation processor 301 communicates with a proxy storage device 302, a mapping storage device 303 and a blank storage device 304. In FIG. 3, these are shown as respective devices but it should be appreciated that these storage areas could be implemented as partitions on a single volume. Alternatively, each representation of a storage device could in itself be implemented by several volumes and said volumes could be configured as a redundant array so as to prevent the loss of data due to disc failure.

In use, a three-dimensional model is selected within the item creation object in response to user input via network 101. Two-dimensional image data 305 is uploaded to the item of creation object from a user (such as user 104) to the item creation object 201. The two-dimensional image data is mapped as a texture onto the three-dimensional model by the image creation object to define a created image data file 306.

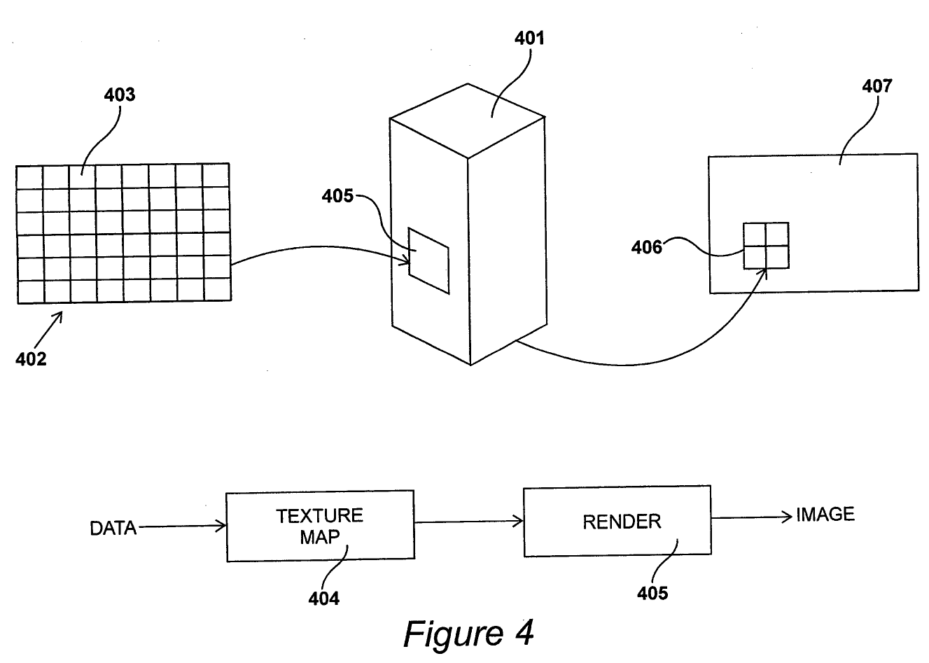

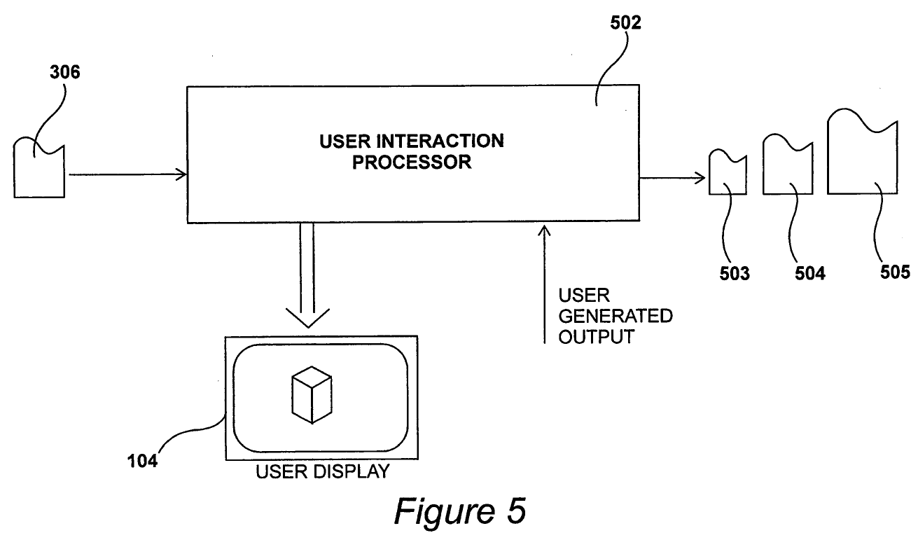

Data for effecting the texture mapping process is stored within the mapping storage device 303. Thus, mapping storage device 303 stores a three-dimensional representation of the package itself along with an appropriate texture map for mapping texels derived from file 305 onto the surface of the three-dimensional image in order to produce created image data file 306 which is then supplied to the interactive object 202. These procedures are detailed further in FIGS. 4 and 5.

In order for a user to select a particular package, it is possible for the user to view package types that are available. When selecting these images, a graphical user interface is supplied to the user populated with examples of the package designs that are available. These designs, along with the interface, are read from proxy storage device 302.

Having selected a particular package style it is then necessary for the user to upload a two-dimensional graphics file. In a preferred configuration, the system is capable of handling virtually any type of graphics file defined in one of many popular graphical formats (such as JPEG, PDF, GIF etc) and for any size and any aspect ratio to be processed, the graphical data being expanded or compressed etc in order to achieve an appropriate fit. However, optimum results are achieved if the two-dimensional graphics file supplied by the user is sympathetic to the application required. Thus, it is preferable for the graphics file to be implemented at a size and shape that obtains best results. If a user is not aware of the preferred shape of a two-dimensional image, it is possible for the user to download an outline, substantially similar to a package “blank”. consequently, these outlines or blanks are downloaded from blank storage device 304. Thus, in this way, it is possible for a new user to make a selection from the three-dimensional packages that are available, obtain details of the preferred representation of the two-dimensional image file and then upload the two-dimensional file. From this, the system generates a three-dimensional and supplies high definition photo-realistic two-dimensional images, for publication purposes, of the three-dimensional object in a selected orientation.

### FIG. 4

An example of texture mapping is illustrated in FIG. 4. The item creation processor 301 manipulates three-dimensional image data 401, effectively defining a “wire frame” for the package. A user (such as user 104) provides a two-dimensional image file for texture 402 as an array of pixels, which in the art are referred to as texels 403. A texture map 404 defines how texels 403 are used to convey properties to the surfaces of the three-dimensional model 401.

Surfaces of model 401 are constructed from a plurality of smaller polygons, such as polygon 405. Polygon 405 is positioned in three-dimensional space by defining the position of its vertices. In addition, the surface of polygon 405 has properties, such as color and transparency etc. These properties are defined by the texture 402 and as such the properties within polygon 405 will be determined with reference to a plurality of texels within the texture 402.

The procedures performed, as defined by the texture map 404, seek to achieve photo-realism such that a rendering operation needs to interpolate between pixels contained within a predefined area so as to achieve an appropriate mixing while taking account of effects due to perspective. Thus, a rendering operation 405 builds pixels, such as pixels 406, within an image frame 407 by making reference to the properties of the polygons, such as polygon 405 while making appropriate interpolations. Thus, the process performed within image creation processor 301 primarily involves the texture mapping procedure 404 in order to create a three-dimensional data file 306, by taking a two-dimensional input file 305 and mapping this data onto a three-dimensional structure as defined by a texture map read from mapping storage device 303.

### FIG. 5

The functionality of user interaction object 202 is illustrated in FIG. 5. A user interaction processor 501 receives the three-dimensional graphics file 306 from the item creation processor 301, via communication channel 204. In a preferred embodiment, a high quality fully scalable three-dimensional representation of the data is retained by the user interaction processor and possibly stored for future use. In addition, a relatively low definition three-dimensional file, preferably a W3D file is produced in order to facilitate user display and interaction.

Thus, a user 104, having a display device, receives image data appearing as a three-dimensional representation of the rendered package. Furthermore, it is possible for the user to manipulate the displayed image using an input device to provide user generated output data back to the user interaction processor 502. In this way, it is possible for a user to manipulate the position and viewing angle etc of the viewed package in three-dimensional space so as to select a particular view from which high definition two-dimensional images may be derived for publication purposes.

The manipulations performed by the user upon the three-dimensional model effectively replicate the sort of operations that would be performed by a photographer when taking a photograph of a real three-dimensional object. The photographer would be in a position to move the package in three-dimensional space, adopt a particular position for their camera and adopt a particular viewing angle.

In order to achieve this degree of operation, it is necessary to download instructions to the user 104 therefore in a preferred embodiment the serving devices are configured to serve executable instructions to a new user so as to allow the new user to interact with the interaction object 202.

Having positioned the object, it is possible for the user to accept a particular position and from this instruct the user interaction processor 402 to produce two-dimensional images for publication purposes. In the example shown in FIG. 5, each rendering operation produces three files, consisting of a low definition file 503 (for local use), a medium definition file 504 (possibly at newspaper print quality and a high definition image file 505, possibly at magazine quality). These files are then supplied to the image storage device 203 via the communications channel 204.

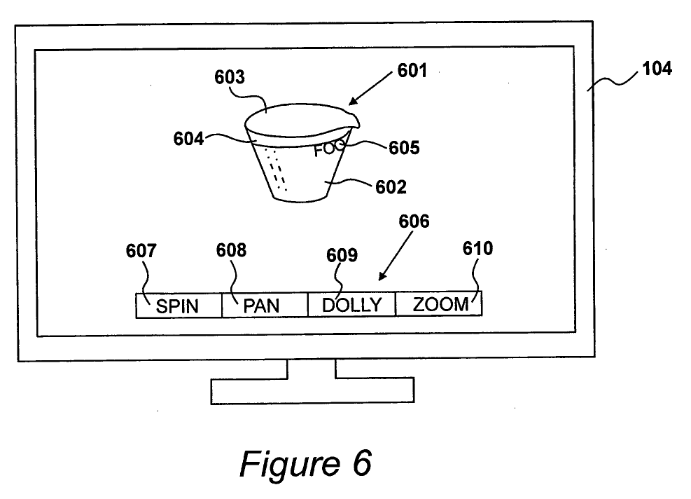

### FIG. 6

An example of an image displayed interactively to the user, as illustrated in FIG. 5, is shown in FIG. 6. In this example, a translucent container 602 is shown having a removable lid 603 attached thereto. Textures have been applied such that the container 602 has a gloss finish whereas the lid 603 has a crinkled effect so as to synthesise the appearance of a foil lid, as would be present in the real article. Furthermore, given that the container 602 is translucent, it is also possible to see a fill level 604 representing the level of a foodstuff contained with in the container 602 when full. Text 605 has also been introduced as would be present on the real retail product.

In order to facilitate the manipulation of the displayed image, a graphical user interface 606 is presented to the user. When using this interface, a particular item is selected by applying a mouse click and the selected parameter is controlled by movement of the mouse until the mouse button has been released. However, it should be appreciated that other types of manual interface may be provided to facilitate the selection and tweaking of the viewed data.

In response to operation of the selection button 607, it is possible to spin the displayed object about a vertical axis or about a horizontal axis. Similarly, upon selection of a button 608, it is possible to pan a notional viewing location, such that the product is placed either to the left of the screen, giving emphasis to its right side or, alternatively, to the right of the screen thereby giving emphasis to the left side.

The selection of button 609 is referred to as “dolly” and is akin to moving the camera closer to or further away from the displayed image. A zoom facility, selected by the operation of button 610, achieves a similar effect but by increasing or decreasing the viewing angle. Thus, by the application of buttons 609 and 610 it is possible to adjust the size and perspective of the rendered image. However, it should be appreciated that other items within the graphical user interface may be used, for example a perspective tool could be used in order to manipulate the displayed image.

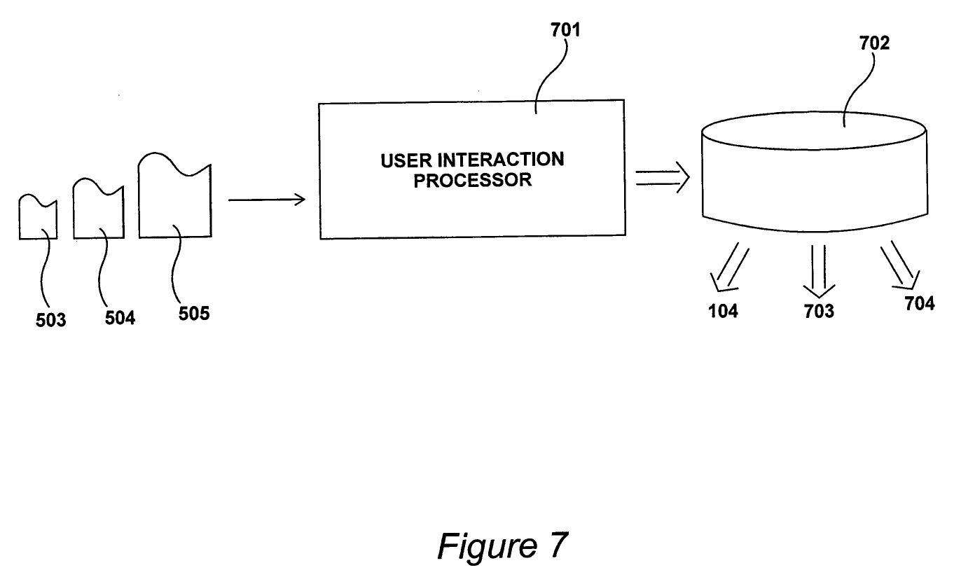

### FIG. 7

The functionality of the image storage object 203 is illustrated in FIG. 7. An image storage processor 701 receives the image files 503, 504 and 505 from the user interaction processor 502 via the communication channel 204. The image storage processor 701 stores the two-dimensional image files in an image store 702, preferably provided with redundancy for data protection. From the image store it is possible to transmit stored images back to the user 104, to electric publishers 703 and to conventional publishers 704 etc. Thus, the serving devices 102 are provided with processing capabilities for storing and transmitting the publication image data to various publishing organisations. It is also possible for first publication data to be produced at a first (newsprint) definition and second publication data to be produced at a second (magazine) definition.

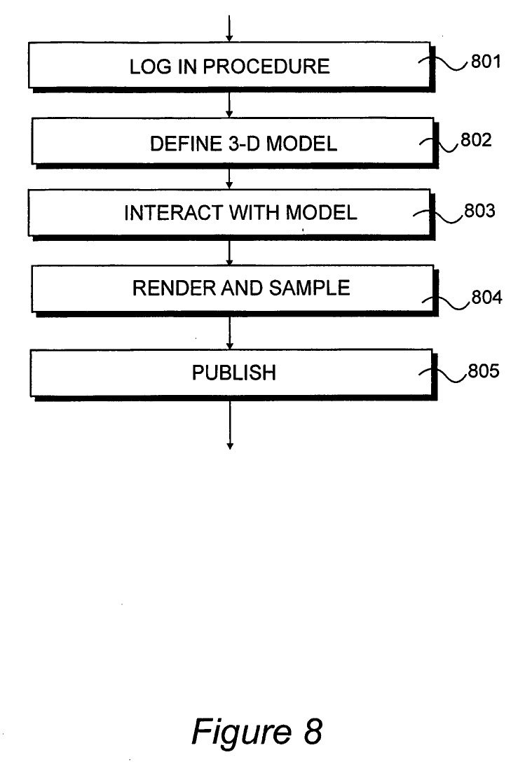

### FIG. 8

An overall method for the production of image data of retail packages for publication purposes is illustrated in FIG. 8. At step 801 a log-in procedure is effected, possibly invoking standard log-in procedures such as the establishment of a user identification and a password. The log-in procedure will also determine the level of access that a user may be given. Thus, a user may be performing a evaluation process and as such may be given a level of access so as to obtain an appreciation of the system without being able to produce final output.

A next level of access may allow non-commercial users to make use of the system, possibly for educational purposes. Thereafter, direct users may be given access and as such they may have licensed the system for generation of images for a particular product or for a number of products within a particular project. A higher level of functionality would be provided to agencies where it would be possible for them to identify particular clients and projects within client's definitions.

At step 802 a three-dimensional model is defined, consisting of the three-dimensional shape with the user's texture applied thereto; effectively deploying the procedures described with respect to FIG. 4.

At step 803 it is possible for a user to interact with the model, as described with reference to FIG. 5. Thereafter, at step 804 the model is rendered and stored and at step 805 the two-dimensional images are published.

Thus, the three-dimensional model data is stored at a server for selection by a user over a network. At the server, selected model data is identified in response to a user selection and two-dimensional image data is uploaded from the user to the server. The two-dimensional image data uploaded from the user is mapped as a texture onto the selected model data. Rendered images are supplied interactively to an interactive user to allow the interactive user to define a preferred view. Thereafter publication image data is rendered in accordance with the preferred view identified by the user, for publication purposes.

As previously described, the three-dimensional model data defines vertices in three-dimensional space. The selected model data is selected by supplying a graphical user interface to a user via the network.

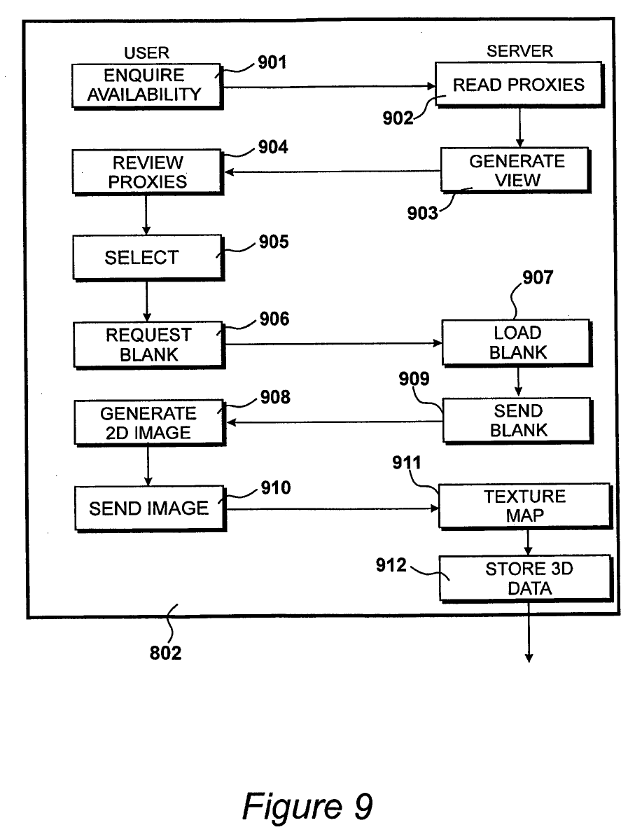

### FIG. 9

Procedures 802 for defining the three-dimensional model are detailed in FIG. 9. At 901 a user makes an enquiry as to the availability of a particular package design.

At 902 a server reads proxy data from proxy store 302 and generates a view at step 903.

At step 904 a user reviews the proxies received from the server and makes a selection at step 905. On the assumption that the user is unfamiliar with the service and is unaware as to the nature of the two-dimensional image required, a request is made at step 906 for a blank, that is to say a template showing the preferred configuration of the two-dimensional image.

At step 907 the server loads the appropriate blank from the blank storage device 304 and at step 909 the blank data is sent to the user.

At step 908 the user generates a two-dimensional image having a configuration compatible with the blank received from the server. At step 910 the image data is uploaded to the server.

At step 911 the server performs the texture mapping exercise, as described with reference to FIG. 4 and stores the resulting three-dimensional data at step 912.

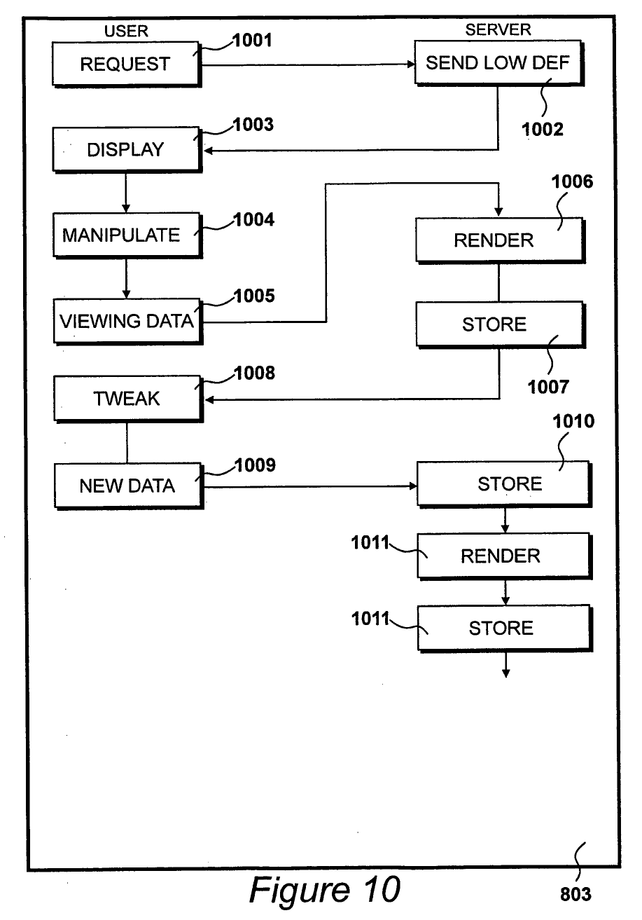

### FIG. 10

Procedures 803 for interacting with the three-dimensional data are detailed in FIG. 10. At step 1001 the client makes a request for the low definition three-dimensional data to be downloaded.

At step 1002 the server downloads the three-dimensional data (generated as part of the texture mapping operation) to a user.

At step 1003 the user displays the downloaded three-dimensional data and at step 1004 manipulations are performed upon this data. These manipulations may be performed locally resulting in a data stream being returned back to the server. Alternatively, images may be downloaded from the server in response to each individual operation, with a data file being collected at the server for subsequent deployment. At step 1005 viewing data is returned to the server.

At step 1006 the server performs a rendering operation based on the viewing data supplied by the user. The resulting two-dimensional graphical images (503, 504 and 505) are stored at step 1007.

At step 1008 it is possible for the user to review the data again and make further minor alterations referred to as tweaking. After tweaking, new data is generated and returned to the sender.

At step 1010 the server stores the new data and performs a rendering operation at step 1011. The rendered files are stored at step 1012.

Thus, it can be appreciated that mapping data is defined for each of the three-dimensional models and an uploaded two-dimensional image is mapped onto the surface of the three-dimensional model in accordance with this mapping data. Thereafter it is possible to render two-dimensional images at any preferred definition.

1. Apparatus for producing image data representing retail packages for publication purposes, comprising data serving devices configured to communicate with a plurality of users over a network, wherein:
said data serving devices include storage and processing capabilities for an item-creation object and a user-interactive object;
a three-dimensional model is selected within said item-creation object in response to user input via said network;
two-dimensional image data is uploaded to said item creation object from said user via said network;
said two-dimensional image data is mapped as a texture onto said three-dimensional model by the image creation object to define created image data;
said created image data is supplied to said interactive object;
said interactive object returns interactive image data to an interactive user;
said interactive object receives a definition of a preferred view from said interactive user; and
said interactive object renders publication image data for publication purposes.

2. The apparatus as claimed in claim 1, wherein said data serving devices also includes storage and processing capabilities for storing and transmitting said publication image data.

3. The apparatus as claimed in claim 2, wherein said serving devices are configured to transmit publication data to a publishing facility.

4. The apparatus as claimed in claim 3, wherein said serving devices are configured to transmit first publication data produced at a first (news print) definition and second publication data at a second (magazine) definition.

5. The apparatus as claimed in claim 1, wherein said serving devices are configured to serve executable instructions to a new user so as to allow said user to interact with said interactive object.

6. A method of producing image data of retail packages for publication purposes, comprising the steps of:
storing three-dimensional model data at a server for selection by a user over a network;
identifying selected model data in response to a user selection;
uploading two-dimensional image data from the user to said server;
mapping said two-dimensional image data uploaded form the user as a texture upon said selected model data;
supplying rendered images interactively to an interactive user to allow said interactive user to define a preferred view; and
rendering publication image data in accordance with said preferred view for publication purposes.

7. The method as claimed in claim 6, wherein said three-dimensional model data defines vertices in three dimensional space.

8. The method as claimed in claim 6, wherein selected model data is selected by supplying a graphical user interface to a user via said network.

9. The method as claimed in claim 6, further comprising the step of downloading an image blank to a user to assist the user in terms of generating appropriate two dimensional image data.

10. The method according to claim 6, wherein mapping data is defined for each said three-dimensional model and an uploaded two-dimensional image is mapped onto surfaces of the three-dimensional model in accordance with said mapping data.
